(19) United States
(12) Patent Application Publication
(10) Pub. No.: US 2022/0176998 A1
(43) Pub. Date: Jun. 9, 2022

(54) Method and Device for Loss Evaluation to Automated Driving

(71) Applicant: Guangzhou Automobile Group Co., Ltd., Guangzhou (CN)

(72) Inventors: Hai XIAO, Sunnyvale, CA (US); Jin SHANG, Sunnyvale, CA (US); Lin CHEN, Guangzhou (CN); Yongling SUN, Guangzhou (CN); Xiaosong YANG, Guangzhou (CN)

(21) Appl. No.: 17/114,528

(22) Filed: Dec. 8, 2020

(51) Int. Cl. B60W 60/00; B60W 30/095; B60W 50/06; B60W 50/00; G06N 7/00; G06N 20/00

(52) U.S. Cl. CPC B60W 60/0015; B60W 30/0956; B60W 50/06; B60W 50/0097; B60W 2554/80; G06N 20/00; B60W 2552/45; B60W 2554/4029; G06N 7/005

(57) ABSTRACT

Provided are methods and devices for loss evaluation to automated driving. The method includes: taking classes or localizations of observations as tasks of an automated driving model; correcting loss of each of the observations based on real-world scenarios in driving practice. In the present disclosure, the evaluation of algorithms in automated driving can be set with true realistic value in real world scenario; and rectify the misalignment from using of generic evaluation methods to algorithms used in automated driving scenarios.

### TECHNICAL FIELD

The present disclosure relates to the field of evaluation of algorithms in automated driving, and particularly to the method and device for loss evaluation to automated driving.

### BACKGROUND

Currently, the evaluation of algorithms in automated driving, specifically learning algorithms are heavily depending upon some near standard and open methods or matrices of general usage of the algorithms in question. For example, an object detection algorithm has been evaluated in a rather generic setting, than any specifics in driving domain.

Typical evaluation methods of targeted algorithms do well in generic setting than in driving domain, there is a misalignment from using of generic evaluation methods to algorithms used in automated driving scenarios, even those algorithms are normally retrained and tailed on data from driving domain. This leads to a suboptimal solution in boosting algorithmic performance in terms of a realistic situation in driving domain.

It is to be noted that the information disclosed in this background of the disclosure is only for enhancement of understanding of the general background of the present disclosure and should not be taken as an acknowledgement or any form or suggestion that this information forms the prior art already known to a person skilled in the art.

### SUMMARY

Embodiments of the present disclosure provide methods and device for loss evaluation to automated driving, and intend to solve the problem of there is a misalignment from using of generic evaluation methods to algorithms used in automated driving scenarios.

According to an embodiment of the present disclosure, a method for loss evaluation to automated driving is provided, and the method includes: taking classes or localizations of observations as tasks of an automated driving model; correcting loss of each of the observations based on real-world scenarios in driving practice.

In an exemplary embodiment, wherein correcting loss of each of the observation comprises: correcting a multinomial logistic loss or cross entropy loss of each observation.

In an exemplary embodiment, wherein correcting a multinomial logistic loss or cross entropy loss of each observation by the following formula:

Lₒ′=wₒ·Lₒ=−wₒ·Σ_{c=1}^{M}y_{o,c} log(p_{o,c}),

where, Lₒ represents a loss of the observation o; Wₒ represents a contextual weight for the observation o; M represents the number of classes; log represents the nature log; P_{o,c} represents predicted probability of observation o is of class c; y_{o,c} represents binary indicator 0 or 1, if c is the correct class label for observation o, then the value of y_{o,c} is 1, otherwise, the value of y_{o,c} is 0.

In an exemplary embodiment, wherein the weight Wₒ is contextual aware and is defined by class of the object or by size of the object or by distance of the object.

In an exemplary embodiment, wherein correcting loss of each of the observation comprises: correcting a regression loss of each observation.

In an exemplary embodiment, wherein correcting the regression loss of each observation by the following formula:

L′_{loc}=wₒ·L_{loc}

wherein L_{loc} represents localization loss of each observation; Wₒ represents a contextual weight for the observation o.

In an exemplary embodiment, correcting loss of each of the observations based on real-world scenarios in driving practice comprises: weighting a loss from an error based on a distance from an object to an observer, wherein an error object incur lower loss if the object is farther away.

In an exemplary embodiment, correcting loss of each of the observations based on real-world scenarios in driving practice comprises: weighting a loss according to the class type of an object, wherein mis-classify on pedestrian incur a higher loss than vehicle.

In an exemplary embodiment, correcting loss of each of the observations based on real-world scenarios in driving practice comprises: augmenting a loss on an error object based on the scene, wherein mis-identify a pedestrian on crosswalk incur higher loss than a pedestrian on sidewalk.

In an exemplary embodiment, correcting loss of each of the observations based on real-world scenarios in driving practice comprises: to learning based action algorithm, collision to people incur a bigger loss than other objects.

According to another embodiment of the present disclosure, a device for loss evaluation to automated driving is provided. The device may include: an automated driving module, configured to take classes or localizations of observations as tasks of an automated driving model; a correction module, configured to correct loss of each of the observations based on real-world scenarios in driving practice.

In an embodiment of the present disclosure, a non-volatile computer readable storage medium is provided, a program is stored in the non-volatile computer readable storage medium, and the program is configured to be executed by a computer to perform the steps of methods in above-mentioned embodiments.

In an embodiment of the present disclosure, an automated vehicle is provided. The automated vehicle includes the device for loss evaluation to automated driving in above-mentioned embodiments.

Through the above-mentioned embodiments of the present disclosure, the concept in the above embodiment can set the evaluation of algorithms in automated driving with true realistic value in real world scenario; and rectify the misalignment from using of generic evaluation methods to algorithms used in automated driving scenarios.

### BRIEF DESCRIPTION OF THE DRAWINGS

The drawings described here are adopted to provide a further understanding to the present disclosure and form a part of the application. Schematic embodiments of the present disclosure and descriptions thereof are adopted to explain the present disclosure and not intended to form limits to the present disclosure. In the drawings:

FIG. 1 is a flowchart of a method for loss evaluation to automated driving according to an embodiment of the present disclosure;

FIG. 2 is a structure block diagram of a device for loss evaluation to automated driving according to another embodiment of the present disclosure; and

FIG. 3 is a structure block diagram of an automated vehicle according to an embodiment of the present disclosure.

### DETAILED DESCRIPTION OF THE EMBODIMENTS

The present disclosure will be described below with reference to the drawings and in combination with the embodiments in detail. It is to be noted that the embodiments in the application and characteristics in the embodiments may be combined without conflicts.

### Embodiment 1

In the present embodiment, a method for loss evaluation to automated driving is provided, in the present embodiment, the evaluation methodologies have been rectified, so that the assessment that they establish will have a more tangible and physical meaning, such as a mis-detection of far away object would have less severity than a close-by object, likewise, a mis-classify of pedestrian would be much more serious than a rigid body if both were at the same location. This new concept advances algorithmic evaluations over existing ones in such a way that these real-world scenarios in driving practice are well factored in, so that once algorithms are tailed with these evaluations, they will be further fitted to the use cases in driving domain.

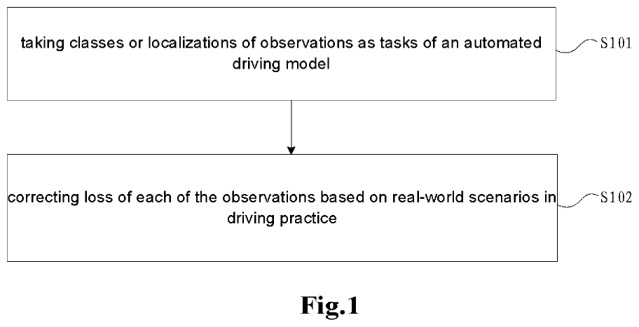

As shown in FIG. 1, the method includes the following steps.

At S102, taking classes or localizations of observations as tasks of an automated driving model;

At S104, correcting loss of each of the observations based on real-world scenarios in driving practice.

In the present embodiment, the step of S102 may comprise: correcting a multinomial logistic loss or cross entropy loss of each observation.

In the present embodiment, wherein correcting a multinomial logistic loss or cross entropy loss of each observation by the following formula:

$${{L}^{′}}_{o} = {w}_{o} \cdot {L}_{o} = - {w}_{o} \cdot {\sum }_{c = 1}^{M} {y}_{o , c} log ( {p}_{o , c} )$$

where, Lₒ represents a loss of the observation o; wₒ represents a contextual weight for the observation o; M represents the number of classes; log represents the nature log; p_{o,c} represents predicted probability of observation o is of class c; y_{o,c} represents binary indicator 0 or 1, if c is the correct class label for observation o, then the value of y_{o,c} is 1, otherwise, the value of y_{o,c} is 0.

In the present embodiment, wherein the weight wₒ is contextual aware and is defined by class of the object or by size of the object or by distance of the object.

In the present embodiment, the step of S104 may include: correcting a regression loss of each observation.

In the present embodiment, wherein correcting the regression loss of each observation by the following formula:

L′_{loc}=wₒ·L_{loc}

wherein L_{loc} represents localization loss of each observation; wₒ represents a contextual weight for the observation o.

In the present embodiment, the step of S104 may include: weighting a loss from an error based on a distance from an object to an observer, wherein an error object incur lower loss if the object is farther away.

In the present embodiment, the step of S104 may include: weighting a loss according to the class type of an object, wherein mis-classify on pedestrian incur a higher loss than vehicle.

In the present embodiment, the step of S104 may include: augmenting a loss on an error object based on the scene, wherein mis-identify a pedestrian on crosswalk incur higher loss than a pedestrian on sidewalk.

In the present embodiment, the step of S104 may include: to learning based action algorithm, collision to people incur a bigger loss than other objects.

### Embodiment 2

The basic strategy of the present embodiment is to bring real world potentials into algorithmic evaluation of driving domain, which will in turn help to enhance the algorithmic performance and confine its functional limitation and side effect to a narrowed scope, by circulating the training or refining of the data driven algorithms of interest.

In the present embodiment, assume the targeted algorithm are data driven and can be tailed and refined though training process with a properly defined LOSS function as main evaluation matrix.

Legacy LOSS and evaluation matrix have overlooked many differentiators including but not limited to following factors, herein we propose new concepts to consider during implementation of algorithms and their evaluation in the driving domain.

1) Weight the loss (with a ratio) from an error based on the target's distance to observer. One nature example is that an errored target would incur lower loss if it is farther away.

2) Weight the loss according to the target's categorical type. For example, a mis-classify on pedestrian would incur a higher loss (therefore algorithmic penalty as consequence) than a front leading vehicle.

3) Augment the loss on an errored target considering the scene and semantic meaning, for example mis-identify a pedestrian on crosswalk would incur much higher loss than a pedestrian on sidewalk.

4) To learning based action algorithms, collision to people can incur bigger algorithmic loss.

In the present embodiment, by incorporating this new concept into the automated driving area, it will enhance evaluation of the algorithms being used, which will further lead to more practical data models with the algorithms being returned. This in the end will enable better algorithmic performance to better product and customer experience.

### Embodiment 3

In the present embodiment, the implement of loss evaluation is provided.

In the present embodiment, herein rectified Loss (object) function (to train a better model by our concept) by examples:

1. Take multi-classes classification as a task or subtask of a model.

Assume original multinomial logistic loss or cross entropy loss of each observation (each sample) is defined as (according to current practice):

$${L}_{o} = - {\sum }_{c = 1}^{M} {y}_{o , c} log ( {p}_{o , c} )$$

Where:
M—number of classes;
log—the nature log;
y_{o,c}—binary indicator (0 or 1), 1 if c is the correct class label for observation o;
p_{o,c}—predicted probability of observation o is of class c.

In the present embodiment, according to the solution of the present disclosure, we propose to extend it (the loss of each observation) as:

$${L}_{o}^{′} = {w}_{o} \cdot {L}_{o} = - {w}_{o} \cdot {\sum }_{c = 1}^{M} {y}_{o , c} log ( {p}_{o , c} )$$

Where:
Lₒ—the same loss term of this observation as above;
wₒ—the contextual weight term for this observation;
wₒ—is the key concept of our introduction;
this weight is contextual aware and it is flexible to define, for example,
w_{pedestrian}>w_{bike}>w_{truck}>w_{car} (by class), or
w_{small_object}>w_{medium_object}>w_{large_object} (by size), or
w_{near-object}>w_{middle_object}>w_{farther_object} (by distance).

2. Take localization of objects as a task or subtask of a target model (e.g. identify bounding box of an object in camera view/image)

Assume an original regression loss (L1 or L2 regression loss) or target of each sample object's bounding box is defined as (according to current/previous practice):

$${L}_{l o c} = {L}_{bbox} = {{\sum }^{Corners}}_{c = 1} {L}_{L 1 / 2 \_regression} ( c , o ) = {\sum }_{c = 1}^{Ctr , w , h} {L}_{L 1 / 2 \_regression} ( c , o )$$

Wherein:
loc—localization;
bbox—bounding box
Corners—shape corners;
Ctr, w, h—centers, width, height;
L1/2_regression—Level 1/2 regression term;
o—observation's prediction over the points or dimensions;
c—observation's ground truth of the points or dimensions.

In the present embodiment, according to the solution of the present disclosure, it can be extended (each L_{loc} term) as:

L_{loc}=wₒ·L_{loc}
Where:
L_{loc}—the same localization loss term of each object as defined previously;
wₒ—the contextual weight term for this object in observation;
this weight is contextual aware and it can be defined flexibly just similar as in 1 above.

### Embodiment 4

In the embodiment, a device for loss evaluation to automated driving is provided. The device can be applied to loss evaluation to automated driving, and is configured to implement the abovementioned embodiments with preferred implementation modes. What has been described will not be elaborated. For example, term “module”, used below, may be a combination of software and/or hardware realizing a predetermined function. Although the device described in the following embodiment is preferably implemented by the software, implementation by the hardware or the combination of the software and the hardware is also possible and conceivable.

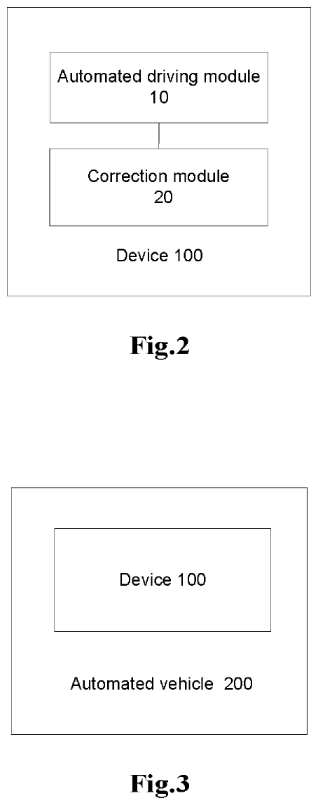

FIG. 2 is a structure block diagram of a device for loss evaluation to automated driving according to an embodiment of the present disclosure. As shown in FIG. 2, the device 100 includes an automated driving module 10 and a correction module 20.

The automated driving module 10 is configured to take classes or localizations of observations as tasks of an automated driving model.

The correction module 20 is configured to correct loss of each of the observations based on real-world scenarios in driving practice.

In the present embodiment, by virtue of the device, advances algorithmic evaluations over existing ones in such a way that these real-world scenarios in driving practice are well factored in, so that once algorithms are tailed with these evaluations, they will be further fitted to the use cases in driving domain.

### Embodiment 5

According to the present embodiment, a non-volatile computer readable storage medium is provided, a program is stored in the non-volatile computer readable storage medium, and the program is configured to be executed by a computer to perform the following steps.

At S1, taking classes or localizations of observations as tasks of an automated driving model;

At S2, correcting loss of each of the observations based on real-world scenarios in driving practice.

In an embodiment, the storage medium in the embodiment may include, but not limited to, various medium capable of storing computer programs such as a U disk, a ROM, a RAM, a mobile hard disk, a magnetic disk or an optical disk.

### Embodiment 6

According to the present embodiment, an automated vehicle is provided. As shown in FIG. 3, the automated vehicle 200 includes the device for loss evaluation to automated driving in above-mentioned embodiments. It is to be noted that in the present embodiment the automated vehicle can be different kinds of vehicles.

It is apparent that those skilled in the art should know that each module or each step of the present disclosure may be implemented by a universal computing device, and the modules or steps may be concentrated on a single computing device or distributed on a network formed by a plurality of computing devices, and may in an embodiment be implemented by program codes executable for the computing devices, so that the modules or the steps may be stored in a storage device for execution with the computing devices, the shown or described steps may be executed in sequences different from those described here in some circumstances, or may form individual integrated circuit module respectively, or multiple modules or steps therein may form a single integrated circuit module for implementation. Therefore, the present disclosure is not limited to any specific hardware and software combination.

The above is only the exemplary embodiments of the present disclosure and not intended to limit the present disclosure. For those skilled in the art, the present disclosure may have various modifications and variations. Any modifications, equivalent replacements, improvements and the like made within the spirit and principle of the present disclosure shall fall within the scope of protection of the present disclosure.

What is claimed is:

1. A method for loss evaluation to automated driving, comprising:
taking classes or localizations of observations as tasks of an automated driving model;
correcting loss of each of the observations based on real-world scenarios in driving practice.

2. The method as claimed in claim 1, wherein correcting loss of each of the observation comprises:
correcting a multinomial logistic loss or cross entropy loss of each observation.

3. The method as claimed in claim 2, wherein correcting a multinomial logistic loss or cross entropy loss of each observation by the following formula:
$${L}_{o}^{′} = {w}_{o} \cdot {L}_{o} = - {w}_{o} \cdot {\sum }_{c = 1}^{M} {y}_{o , c} log ( {p}_{o , c} )$$
where, Lₒ represents a loss of the observation o; wₒ represents a contextual weight for the observation o; M represents the number of classes; log represents the nature log; p_{o,c} represents predicted probability of observation o is of class c; y_{o,c} represents binary indicator 0 or 1, if c is the correct class label for observation o, then the value of y_{o,c} is 1, otherwise, the value of y_{o,c} is 0.

4. The method as claimed in claim 3, wherein the weight wₒ is contextual aware and is defined by class of the object or by size of the object or by distance of the object.

5. The method as claimed in claim 1, wherein correcting loss of each of the observation comprises:
correcting a regression loss of each observation.

6. The method as claimed in claim 5, wherein correcting the regression loss of each observation by the following formula:
L_{loc}=wₒ·L_{loc}
where L_{loc} represents localization loss of each observation; wₒ represents a contextual weight for the observation o.

7. The method as claimed in claim 1, correcting loss of each of the observations based on real-world scenarios in driving practice comprises:
weighting a loss from an error based on a distance from an object to an observer, wherein an error object incur lower loss if the object is farther away.

8. The method as claimed in claim 1, correcting loss of each of the observations based on real-world scenarios in driving practice comprises one or more of the following:
weighting a loss according to the class type of an object, wherein a mis-classify on pedestrian incur a higher loss than vehicle;
augmenting a loss on an error object based on the scene, wherein mis-identify a pedestrian on crosswalk incur higher loss than a pedestrian on sidewalk;
to learning based action algorithm, collision to people incur a bigger loss than other objects.

9. A device for loss evaluation to automated driving, comprising:
automated driving module, configured to take classes or localizations of observations as tasks of an automated driving model;
correction module, configured to correct loss of each of the observations based on real-world scenarios in driving practice.

10. A non-volatile computer readable storage medium, in which a program is stored, the program is configured to be executed by a computer to perform the method as claimed in claim 1.

11. A non-volatile computer readable storage medium, in which a program is stored, the program is configured to be executed by a computer to perform the method for loss evaluation to automated driving as claimed in claim 2.

12. A non-volatile computer readable storage medium, in which a program is stored, the program is configured to be executed by a computer to perform the method for loss evaluation to automated driving as claimed in claim 3.

13. A non-volatile computer readable storage medium, in which a program is stored, the program is configured to be executed by a computer to perform the method for loss evaluation to automated driving as claimed in claim 4.

14. A non-volatile computer readable storage medium, in which a program is stored, the program is configured to be executed by a computer to perform the method for loss evaluation to automated driving as claimed in claim 5.

15. A non-volatile computer readable storage medium, in which a program is stored, the program is configured to be executed by a computer to perform the method for loss evaluation to automated driving as claimed in claim 6.

16. A non-volatile computer readable storage medium, in which a program is stored, the program is configured to be executed by a computer to perform the method for loss evaluation to automated driving as claimed in claim 7.

17. A non-volatile computer readable storage medium, in which a program is stored, the program is configured to be executed by a computer to perform the method for loss evaluation to automated driving as claimed in claim 8.

18. An automated vehicle, which comprises a device for loss evaluation to automated driving as claimed in claim 9.
